(19) United States
(12) Patent Application Publication
(10) Pub. No.: US 2013/0088595 A1
(43) Pub. Date: Apr. 11, 2013

(54) CONTROL OF ELECTRONIC FEATURES AND SAFETY EQUIPMENT FOR A ONE DESIGN RACE CAR

(71) Applicant: Richard S. Nauert, Corona Del Mar, CA (US)

(72) Inventor: Richard S. Nauert, Corona Del Mar, CA (US)

(21) Appl. No.: 13/584,464

(22) Filed: Aug. 13, 2012

Related U.S. Application Data
(60) Provisional application No. 61/524,262, filed on Aug. 16, 2011.

(51) Int. Cl. B60Q 1/26; B60Q 1/46; B60Q 1/44; H04N 7/18; B60Q 1/34

(52) U.S. Cl. CPC B60Q 1/26; H04N 7/18; B60Q 1/34; B60Q 1/44; B60Q 1/46
USPC 348/148; 340/475; 340/471

(57) ABSTRACT

A safety system for a single design racing automobile having a rear mounted airfoil member with an adjustable aerodynamic wing member includes a horizontal light panel with a multiple sections along the rear edge of the wing member, and a control unit programmed to control the sections of the horizontal light panel to be illuminated in synchronization with operation of the automobile's rear brake lights, reverse gear drive lights, turn signal lights, as well as emergency flashing of the lights. The safety system also includes one or more rearward facing cameras mounted to the rear edge of the adjustable aerodynamic wing member.

### CROSS-REFERENCE TO RELATED APPLICATIONS

This application is based upon and claims the benefit of priority from the prior Provisional Application No. 61/524,262, filed on Aug. 16, 2011, the entire contents of which are incorporated herein by reference.

### BACKGROUND OF THE INVENTION

The present invention relates to improvements in safety features and safety equipment for automobiles, and more particularly relates to improvements in control of electronic features and safety equipment for a one design race car.

A rear light cluster for automobiles is known that includes a central unit and two side units, with cells aligned along a substantially horizontal axis and a central cell housing a license plate light, and a pair of flanking cells forming reversing and rear fog lights.

An elevated rear light module for a vehicle is also known that includes a centrally positioned higher candle power lamp, and a pair of low candle power side lamps that intermittently are illuminated together when the vehicle headlights are off, indicating a turn. When the head lights are illuminated the lamps of each pair of lamps alternately illuminate to indicate a turn. When the automobile brakes are applied all lamps of the module illuminate. When the hazard light system of the automobile is activated, the illumination of all lamps of the module alternate on and off. When in addition to the hazard circuit activation the head lamps are turned on, the illumination of the outer most lamps on each end of the module alternate with the center lamp.

While adjustable rear wings or airfoils for race cars are known that are movably mounted so that the angle of attack of the rear wings or airfoils can be adjusted, the nature of the typical mounting of the rear wings or airfoils and the typically thin aerodynamic rear or trailing edge of the rear wings or airfoils do not commonly permit installation of significant rear safety indicator lights or other safety features on such adjustable rear wings or airfoils, and rear indicator lights or other safety lights are commonly only placed on the rear of the body of race car where they can be made large enough in standard positions to readily visible and recognizable. It would be desirable to provide a safety system for a racing automobile including rear brake lights, reverse gear drive lights, and turn signal lights, in combination with a rear airfoil member including an adjustable aerodynamic wing member having a rear edge with a horizontal light panel with a plurality of sections, and a control unit programmed to control the sections of the horizontal light panel to be illuminated in synchronization with operation of the automobile's rear brake lights, reverse gear drive lights, turn signals, and hazard light system, for improved safety of operation of the racing automobile. The present invention meets these and other needs.

### SUMMARY OF THE INVENTION

Briefly and in general terms, the present invention provides for a safety system for a racing automobile having a rear mounted airfoil member including a rear airfoil member including an adjustable aerodynamic wing member having a rear edge with a horizontal light panel with a plurality of sections, and a control unit programmed to control the sections of the horizontal light panel to be illuminated in synchronization with operation of the automobile's rear brake lights, reverse gear drive lights, turn signals, and hazard light system, as well as one or more rearward facing cameras, for improved safety of operation of the racing automobile.

The present invention accordingly provides for a safety system for a racing automobile having a rear end including rear right and left brake lights, rear right and left reverse gear drive lights, and rear right and left turn signal lights, and a rear airfoil member including right and left side mounting members and an adjustable aerodynamic wing member movably mounted therebetween, the adjustable aerodynamic wing member having a rear edge. In a presently preferred aspect, the adjustable aerodynamic wing member includes a horizontal light panel mounted along the rear edge of the adjustable aerodynamic wing member, and the horizontal light panel includes a plurality of sections of lights operated in coordination with the rear right and left brake lights, rear right and left reverse gear drive lights, and rear right and left turn signal lights. In another presently preferred aspect, the plurality of sections of lights include a pair of inside right and left sections of lights, and a pair of outside right and left sections of lights.

The safety system also includes a control unit electrically connected in communication with the rear right and left brake lights, rear right and left reverse gear drive lights, rear right and left turn signal lights, and the plurality of sections of lights. In a presently preferred aspect, the control unit is programmed to control at least a portion of the plurality of sections of lights to be illuminated in synchronization with illumination of at least one of the rear right and left brake lights, the rear right and left reverse gear drive lights, and rear right and left turn signal lights.

In another presently preferred aspect, the rear edge of the adjustable aerodynamic wing member has a surface defining a rearward facing recess, and the plurality of sections of lights of the horizontal light panel are mounted within the rearward facing recess.

In another presently preferred aspect, the horizontal light panel includes a transparent cover mounted over the plurality of sections of lights in the rearward facing recess.

In another presently preferred aspect, the plurality of sections of lights comprise a plurality of LED lights.

In another presently preferred aspect, the control unit is programmed to control the pair of outside right and left sections of lights to be illuminated simultaneously with illumination of the rear right and left brake lights during braking.

In another presently preferred aspect, the control unit is programmed to control the pair of inside right and left sections of lights to be illuminated simultaneously with the rear right and left reverse drive lights when the automobile is in reverse gear.

In another presently preferred aspect, the control unit is programmed to control the outside right and left sections of lights, respectively, to be illuminated simultaneously with illumination of the corresponding rear right or left turn signals, respectively, when a corresponding right or left turn signal switch of the automobile is activated.

In another presently preferred aspect, the control unit is programmed to control operation of the pair of outside right and left sections of lights to be illuminated simultaneously with flashing of the rear right and left brake lights as emergency or hazard lights.

In another presently preferred aspect, the safety system also includes one or more rearward facing cameras mounted to the rear edge of the adjustable aerodynamic wing member, such as left side and right side rearward facing cameras, for example.

In another presently preferred aspect, the one or more rearward facing cameras are mounted in the rearward facing recess.

In another presently preferred aspect, the horizontal light panel includes a clear cover mounted over the one or more rearward facing cameras mounted in the rearward facing recess.

In another presently preferred aspect, the safety system includes a display for displaying at least one view from the one or more rearward facing cameras, such as views from right and left side rearward facing cameras.

In another presently preferred aspect, an upper right corner airfoil reflector panel is mounted on the right side mounting member of the rear airfoil member, and an upper left corner airfoil reflector panel is mounted on the left side mounting member of the rear airfoil member.

These and other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a rear elevational view of a rear end of a racing automobile including a rear light panel of the safety system according to the present invention.

FIG. 2 is an enlarged view of a portion of the rear light panel of the safety system of FIG. 1.

FIG. 3 is an enlarged view of a portion of an upper corner of a side pedestal airfoil mounting member of the safety system of FIG. 1.

FIG. 4A is an enlarged sectional view of the edge portion of the rear light panel of FIG. 1, showing mounting of an LED light.

FIG. 4B is an enlarged sectional view of the edge portion of the rear light panel of FIG. 1, showing mounting of a camera.

FIG. 5 is a schematic diagram of the electrical features of the safety system according to the present invention.

### DETAILED DESCRIPTION OF THE PREFERRED EMBODIMENTS

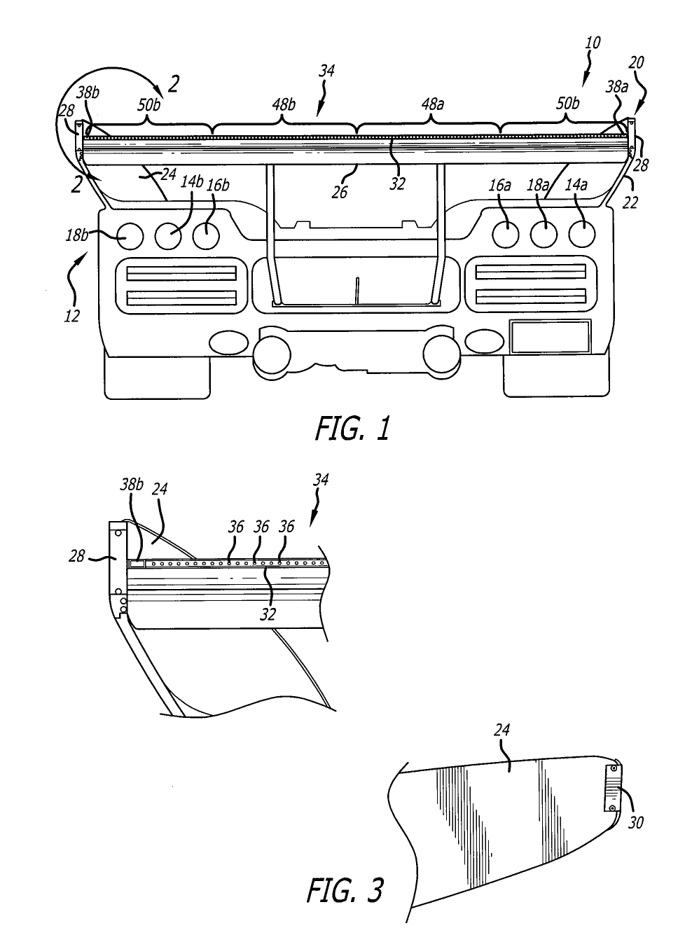

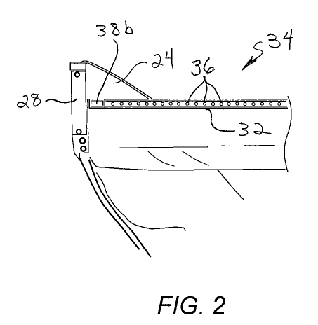

Referring to the drawings, which are provided for purposes of illustration of the invention by way of example, and not by way of limitation, the present invention provides for a safety system for a single design racing automobile or sports car 10 having a rear end 12 with rear right and left brake lights 14a, 14b, rear right and left reverse gear drive lights 16a, 16b, and rear right and left turn signal lights 18a, 18b, as shown in FIG. 1. The racing automobile includes a rear airfoil member or spoiler 20, formed by a right side pedestal airfoil mounting member 22, a left side pedestal airfoil mounting member 24, and an adjustable aerodynamic wing member 26 movably mounted between the right and left pedestal airfoil mounting members. In a presently preferred aspect, the right and left side pedestal airfoil mounting members may include upper right and left rear corner airfoil reflector panels 28, and the right and left side pedestal airfoil mounting members may include upper right and left side corner airfoil reflector panels 30, only the left one of which is shown, in FIG. 3.

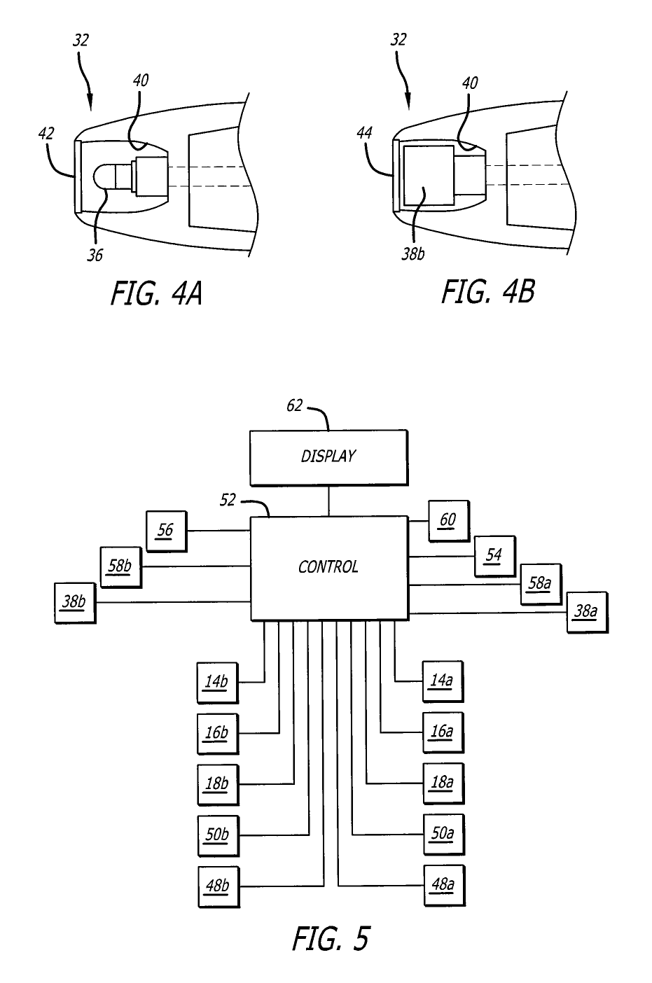

Referring to FIG. 1, the rear edge 32 of rear airfoil wing member preferably includes a horizontal light panel 34 including an array of a plurality of lights 36, such as LED lights, for example, as well as one or more rearward facing cameras, such as left side and right side rearward facing cameras 38a, 38b. As is illustrated in FIGS. 4A and 4B, in a presently preferred aspect, the array of a plurality of lights and the one or more rearward facing cameras are mounted in a recess 40 of the rear edge of rear airfoil wing member, which typically also includes a transparent or semi-transparent cover portion 42 mounted along the rear edge of rear airfoil wing member over the array of a plurality of lights, and which typically includes a clear or transparent cover portion 44 mounted along the rear edge of rear airfoil wing member over the left side and right side rearward facing cameras.

Referring again to FIG. 1, in another presently preferred aspect, the horizontal light panel or array of a plurality of lights is divided into a plurality of sections, typically including inside right and left pairs of sections 48a, 48b, and outside right and left pairs of sections 50a, 50b, of the horizontal light panel or array of a plurality of lights.

Referring to FIG. 5, the single design racing automobile or sports car safety system preferably includes a control unit 52 electrically connected in communication with the rear right and left brake lights, the rear right and left reverse gear drive lights, the rear right and left turn signal lights, and to the plurality of sections of the horizontal light panel or array of a plurality of lights. The control unit preferably includes a programmable microprocessor, and the control unit is programmed to control the outside right and left pairs of sections of the horizontal panel or array of LED lights to be illuminated simultaneously with illumination of the rear right and left brake lights when a brake pedal 54 is pressed during braking. The control unit is also preferably programmed to control the operation of the inside right and left pairs of sections of the horizontal panel or array of LED lights to be illuminated simultaneously with the rear right and left reverse drive lights when the automobile is in reverse gear 56. The control unit is also preferably programmed to control the operation of the outside right and left pairs of sections of the horizontal panel or array of LED lights, respectively, to be illuminated simultaneously with illumination of the corresponding rear right or left turn signals when a corresponding right turn signal switch 58a or left turn signal switch 58b of the automobile is activated. The control unit is also preferably programmed to control the operation of the outside right and left pairs of sections of the horizontal panel or array of LED lights to be illuminated simultaneously with flashing of the rear right and left brake lights as emergency or hazard lights when a hazard light switch 60 is activated. In addition, the control unit is preferably electrically connected to the one or more rearward facing cameras for controlling the operation of the one or more rearward facing cameras, and the control unit preferably includes a display 62 either directly electrically connected to the one or more rearward facing cameras or connected to the one or more rearward facing cameras through the control unit for displaying one or more views from the one or more rearward facing cameras. It should be appreciated that the control unit can be programmed to have various sections of lights of the horizontal light panel be illuminated in other sequences or patterns, as desired, such as directional sequencing of the sections of lights, or alternating flashing on and off, either in coordination with or separately from operation of the rear brake lights, reverse gear drive lights, and turn signal lights, for example.

The single design racing car may also optionally include other safety features, such as a fuel tank modified to provide improved fuel safety protections for the persons in the racing car. For example, while such a racing car may typically have fuel tanks located on right and left sides of the vehicle and be formed of thin aluminum in order to hold up to 80 gallons of fuel, a single fuel tank may be placed on a side of the automobile opposite the driver side, formed of half inch thick steel, have a reduced capacity for fuel, such as about 20 gallons, for example and include an exterior crush panel construction, such as a steel and honeycomb crush panel, for example.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. A safety system for a racing automobile having a rear mounted airfoil member, the safety system comprising:
a racing automobile having a rear end including rear right and left brake lights, rear right and left reverse gear drive lights, and rear right and left turn signal lights;
a rear airfoil member including right and left side mounting members and an adjustable aerodynamic wing member movably mounted therebetween, the adjustable aerodynamic wing member having a rear edge;
a horizontal light panel mounted along the rear edge of the adjustable aerodynamic wing member, said horizontal light panel including a plurality of sections of lights, said plurality of sections of lights including a pair of inside right and left sections of lights, and a pair of outside right and left sections of lights; and
a control unit electrically connected in communication with the rear right and left brake lights, rear right and left reverse gear drive lights, rear right and left turn signal lights, and the plurality of sections of lights, said control unit being programmed to control at least a portion of the plurality of sections of lights to be illuminated in synchronization with illumination of at least one of the rear right and left brake lights, the rear right and left reverse gear drive lights, and rear right and left turn signal lights.

2. The safety system of claim 1, wherein the rear edge of the adjustable aerodynamic wing member has a surface defining a rearward facing recess, and said plurality of sections of lights of said horizontal light panel are mounted within said rearward facing recess.

3. The safety system of claim 2, wherein said horizontal light panel includes a transparent cover mounted over said plurality of sections of lights in said rearward facing recess.

4. The safety system of claim 1, wherein said plurality of sections of lights comprise a plurality of LED lights.

5. The safety system of claim 1, wherein said control unit is programmed to control the pair of outside right and left sections of lights to be illuminated simultaneously with illumination of the rear right and left brake lights during braking.

6. The safety system of claim 1, wherein said control unit is programmed to control the pair of inside right and left sections of lights to be illuminated simultaneously with the rear right and left reverse drive lights when the automobile is in reverse gear.

7. The safety system of claim 1, wherein said control unit is programmed to control the outside right and left sections of lights, respectively, to be illuminated simultaneously with illumination of the corresponding rear right or left turn signals, respectively, when a corresponding right or left turn signal switch of the automobile is activated.

8. The safety system of claim 1, wherein said control unit is programmed to control operation of the pair of outside right and left sections of lights to be illuminated simultaneously with flashing of the rear right and left brake lights as emergency or hazard lights.

9. The safety system of claim 1, further comprising at least one rearward facing camera mounted to the rear edge of the adjustable aerodynamic wing member.

10. The safety system of claim 9, wherein said at least one rearward facing camera comprises left side and right side rearward facing cameras.

11. The safety system of claim 9, wherein the rear edge of the adjustable aerodynamic wing member has a surface defining a rearward facing recess, and wherein said at least one rearward facing camera is mounted in the rearward facing recess.

12. The safety system of claim 11, wherein said horizontal light panel includes a clear cover mounted over said at least one rearward facing camera is mounted in the rearward facing recess.

13. The safety system of claim 9, further comprising a display for displaying at least one view from said at least one rearward facing camera.

14. The safety system of claim 10, further comprising a display for displaying views from said right and left side rearward facing cameras.

15. The safety system of claim 1, further comprising at least one upper right corner airfoil reflector panel mounted on said right side mounting member of said rear airfoil member, and at least one upper left corner airfoil reflector panel mounted on said left side mounting member of said rear airfoil member.
